(19) United States
(12) Patent Application Publication
(10) Pub. No.: US 2020/0118535 A1
(43) Pub. Date: Apr. 16, 2020

(54) STRINGED INSTRUMENT PICKUP AND FEEDBACK SYSTEM

(71) Applicant: HUIZHOU DOUBLE ACOUSTICS CO., LTD., Huizhou (CN)

(72) Inventor: SHIQIANG HUANG, Huizhou (CN)

(21) Appl. No.: 16/660,150

(22) Filed: Oct. 22, 2019

Related U.S. Application Data
(63) Continuation of application No. PCT/CN2018/114183, filed on Nov. 6, 2018.

(30) Foreign Application Priority Data
Jan. 12, 2018 (CN) 201520053261.4
Jan. 12, 2018 (CN) 201820053261.3

(51) Int. Cl. G10H 3/18

(52) U.S. Cl. CPC G10H 3/181; G10H 2220/461

(57) ABSTRACT

A stringed instrument pickup and feedback system, comprising a sound pickup device disposed on a string instrument. The sound pickup device comprises a transducer and at least one pickup, a sound processing circuit and a power supply. The pickup activates the transducer to realize resonance enhancement on the instrument body. The transducer is disposed on the string instrument unrestricted by internal bracing. The instrument can be any of pickup, guitar, ukulele, violin, Guqin, Guzheng and Mandolin. The present invention enables the construction of stringed instrument to add vibration and amplify sound of a stringed instrument using the transducer and thus reduce the dependence on rare woods in manufacturing these instruments.

### CROSS-REFERENCE TO RELATED APPLICATIONS

The present application is a continuation in part application of International Application No. PCT/CN20181114183 filed on Nov. 6, 2018, which claims priority to Chinese Patent Application No. 201820053261.3 filed on Jan. 12, 2018 and priority to Chinese Patent Application No, 201820053261.4 filed on Jan. 12, 2018 the contents of both are incorporated by reference herein in their entirety for all purposes.

### FIELD OF ART

The invention is included in the field of instrument sound pickup technology, concerning a stringed instrument pickup and feedback system.

### BACKGROUND

Most stringed instruments on the market use a sound cavity to hear or improve the overall sound quality of the instrument. These instruments include guitars, ukuleles, violins, guqins and guzheng. However, the physical properties of the materials used to make such instruments limit the volume of sound produced by such instruments. Simply put the sound amplification will not be too high. When playing instruments without amplification of external speakers, the sound volume is often too low, not loud enough. If the audience is fir away from the performer using the stringed instrument without a speaker, the audience cannot clearly hear the music played by the performer(s), which makes wonderful performances greatly reduced.

In order to solve this drawback, almost all instrument manufacturers in the world spare no efforts to use rare woods in manufacturing instrument. Rare woods have better resonance to increase sound volume and enhance sound quality of instruments. However, use of well-known rare woods in instrument manufacturing works little on enhancing the sound resonance of instruments. Also, when instrument sound cannot be optimized, many instrument manufacturers continue to pursue even rarer and higher-end woods in instrument manufacturing. This results in overcutting of various types of rare woods. Acacia, rosewood, ebony and sandalwood are commonly used to make instruments and these woods suffer devastating worldwide overcutting and are protected by international conventions to curtail such exploitation.

An invention is desired that will enable a performer to play a stringed instrument and get studio-quality post effects like reverb, delay and chorus without an amplifier, sound system or external effects. An invention is desired that improves the sound quality or tone of a stringed musical instrument and simultaneously reduces the dependence on using rare woods by the instrument manufacturing industries. An invention is desired that picks up the sound of an instrument directly. An invention is desired that applies a resonance speaker or a transducer to realize resonance enhancement of an instrument body and make the sound emitted by the instrument stronger. A stringed instrument is desired that employs a transducer coupled to a back of such instrument and uses the inertia of the original note to continue the momentum of an acoustic wave in a sympathetic vibration wherein such a wave is transferred into the wood of the musical instrument thus using the entire body of the musical instrument to amplify the effect. An invention is desired that, in addition to commonly used volume and tone control functions, adds a digital reverberation module and an effect module having good practicability and broad market sales. An invention is further desired to have on-board circuitry to enhance sound and provide thick chorus effect and brilliant acoustic delay that is both speed and depth adjustable. An invention is desired that uses a built-in preamp.

It is further desired to have an invention that amplifies instrument sound. It is desired that a resonance speaker or transducer is clung, affixed or disposed to the inside, back surface of an instrument panel. It is desired that the instrument have a transducer that is permanently fixed to the inside back. It is further desired that the transducer is permanently fixed inside the instrument with adhesive. It is desired that a eat have a device that is able to pick up the sound made by the instrument, enhance resonance of the instrument and increase the sound made by an instrument. It is also desired that an invention permits the manufacture of an instrument while simultaneously promoting environmental protection. It is also desired that an instrument be manufactured with low material cost and manufacturing costs to permit broad market sales and good economic benefit.

### SUMMARY

The present invention provides a way to make an instrument sound which has been strengthened while at the same time reduce the manufacturing of instruments with rare or exotic materials. The present invention discloses a stringed instrument pickup and feedback system comprising at least one sound pickup member, an output transducer, and a control processor connected to the at least one sound pickup member and the output transducer, wherein the control processor is configured to receive signals from the at least one sound pickup member corresponding to detected sound from a stringed instrument and process said received signals into output control signals, wherein the control processor is configured to send said output control signals to the output transducer to resonate the output transducer through a predetermined range of frequencies. The transducer is disposed on an inside, back surface of the stringed instrument and connected with a power supply or a power amplifier circuit.

### BRIEF DESCRIPTION OF THE DRAWINGS

FIG. 1 shows an exploded perspective view of a stringed instrument pickup and feedback system with an instrument pickup and transducer.

FIG. 2 show a perspective side-view of the stringed instrument pickup and feedback system of FIG. 1, showing the instrument pickup and transducer in an installed position according to an exemplary embodiment.

FIG. 3 shows a plan view of the stringed instrument pickup and feedback system of FIG. 1, showing the instrument pickup and transducer iii an installed position.

FIG. 4 shows a perspective exploded view of the instrument pickup and transducer.

### DETAILED DESCRIPTION

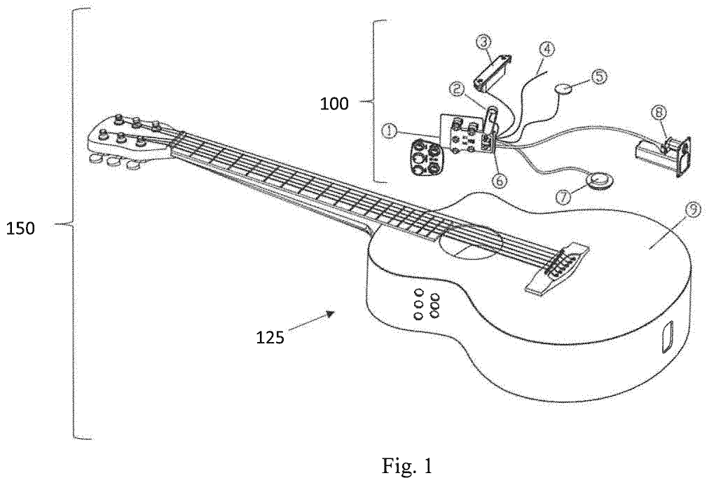

FIGS. 1 to 4 show a stringed instrument pickup and feedback system 150 also known as a stringed instrument same-frequency or co-frequency vibration adding/enhancing and sound amplifying/reinforcement technology. The system 150 comprises an instrument 125 and a sound pickup device 100 or called a sound collecting device. The sound pickup device 100 realizes resonance enhancement and sound adding to an instrument body 9 by means of the instrument vibration adding component or an output transducer 7 which may also be called a resonance speaker or resonant horn. The output transducer 7 is disposed on, affixed or clung to the instrument 9 and connected with a power source 8 or power amplifier circuit.

The transducer may be affixed in a number of different ways both within and outside the instrument 9. The transducer 7 may be affixed using any attachment method. In one non-limiting attachment method, the transducer 7 may use a permanent adhesive such that the transducer is affixed to the back surface of the instrument without the need for internal bracing members. In such embodiment using adhesive, the transducer 7 is attached so not to be removed and, if removed, would cause damage to the transducer 7. In yet another embodiment, the transducer 7 may employ magnets such as neodymium rare earth magnets. The use of the transducer 7 in the present invention replicates the digitally affected sound that is achieved when using rare quality woods in stringed instruments. The use of the sound pickup device 100 with the transducer 7 on the instrument body 9 amplifies the instrument sound. Specifically, by affixing a transducer 7 to an inside surface of an instrument panel internal sound is captured and amplified.

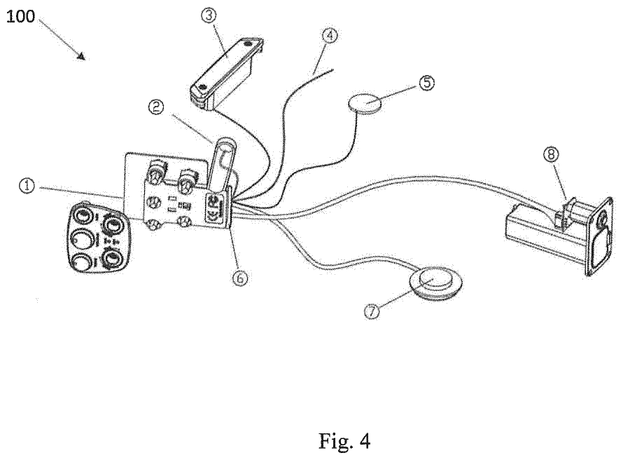

FIG. 4 shows, the sound pickup device 100 of the stringed instrument pickup and feedback system 150. The sound pickup device 100 comprises a sound pickup assembly, a sound processing circuit 6, a transducer or resonance speaker 7 and a power supply unit 8. In one embodiment, the pickup device 100 is a sound receiver, which unlike prior art devices where pickups sends signals to another device.

The sound pickup assembly comprises a control processor or digital sound processor 1 and a sound pickup part or member 2-5 mounted on or to the instrument body 9. A sound processing circuit 6 is placed inside the instrument body 9. The transducer 7, the sound pickup part or member 2-5 and the power supply unit 8 are each connected with the sound processing circuit 6 by wire, respectively.

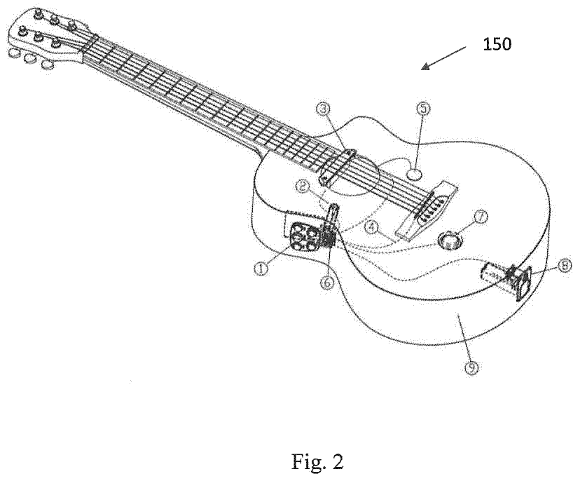

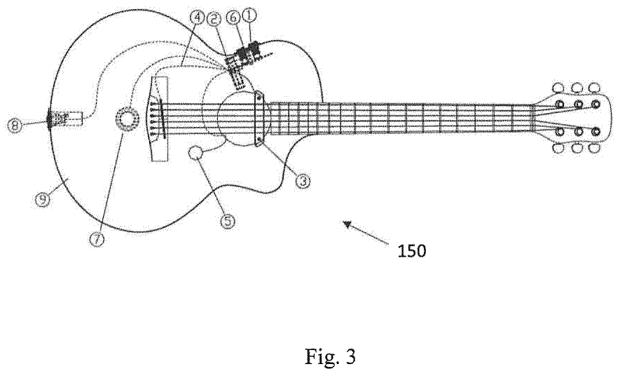

The sound pickup part or member 2-5 can be any one or two or more of coil inductive pickup or magnetic pickup 3, microphone pickup 2, piezoelectric pickup strip or piezoelectric saddle pickup 4 and patch piezoelectric ceramic buzzer pickup or pressure pickup 5. Each of the pickups 2-5 are designed to detect sound produced by the stringed instrument 9 and convert the detected sound to a corresponding electrical signal. As seen in FIGS. 2-3, microphone pickup 2 is installed within the stringed instrument 9 body.

In one embodiment the four sound pickup part or member 2-5 are disposed within instrument 9, wherein a microphone pickup 2 is mounted at one side of the instrument body 9; while a coil induced pickup or magnetic pickup 3, a piezoelectric pickup strip or piezoelectric saddle pickup 4 and a patch piezoelectric ceramic buzzer pickup or pressure pickup 5 are connected with the sound processing circuit 6 by wires, respectively. In another embodiment, magnetic pickup 3 is installed within the sound hole of stringed instrument 125 directly below the strings. Piezo saddle pickup 4 is installed within the saddle of the stringed instrument 125. Pressure pickup 5 is installed on the stringed instrument body 9 either within the body or on the external surface of the soundboard. The detected signal from each of the pickups 2-5 is converted to an electrical signal which is sent to the control processor 1 via a connecting wire.

The control processor or digital signal processor 1, in an exemplary embodiment, processes detected signals from at least one of pickup types 2-5. It can be appreciated that any combination of pickups or a single pickup can be utilized in the subject invention depending on desired sound characteristics and string instrument type as would be known in the art.

Once control processor or digital sound processor 1 has processed the incoming detected signal from one of the pickups 2-5, an output control signal is sent to output transducer 7. Output transducer 7 converts incoming electrical control signals to a vibration movement which resonates the body of stringed instrument 9. The vibration produced by output transducer 7 can be adjusted by control processor or digital sound processor 1 to produce a tone simulating the use of exotic or rare material for the body of the stringed instrument 9. Output transducer 7 can also be used to increase the output sound of stringed instrument 9 by controlling the output control signal by control processor or digital sound processor 1.

The sound processing circuit 6 comprises a volume control unit, a tone processing unit, a power amplifier circuit, a voltage stabilization circuit, a reverberation module and an effect module, and the units and/or modules are electrically connected. The volume control unit is used for volume control of instrument pickup signals; the timbre/tone processing unit is used for timbre/tone processing of instrument pickup signals; the voltage stabilizing circuit is used for voltage enhancement and stabilization; the reverberation module is used for instrument to have reverberation effect. The reverberation module can be one or several adjustable and optional reverberation control modules. The effect module can be one or several adjustable and optional sound effect control modules. The original sound, such as the sound produced by the instrument, is processed, in one embodiment, with control processor or digital sound processor 1 and sound processing circuit 6. The power supply unit 8 is a power supply device 8 connected to and supplies power to the sound processing circuit 6, the instrument vibration adding/enhancing assembly or transducer 7 and sound pickup assembly comprising control processor 1 and pickup members 2-5.

As shown in FIGS. 1 to 4, for application of the sound pickup device on instrument, the instrument makes use of the sound pickup device to realize resonance enhancement on the instrument body 9 by means of the transducer 7. The transducer 7 is clung, affixed or disposed to the inside surface of instrument panel to realize instrument sound amplification, so that sound quality is clear. This is further made true as the transducer 7 has no box standing wave. Besides, the transducer 7 also has a unique characteristic—penetrability, namely the transducer 7 can let sound effect pass through media and music can be heard at the other side, so that the audience at both sides of media can hear beautiful music. The stringed instrument pickup and feedback system of the invention uses the sound pickup device 100 to resonate the instrument body 9 through the transducer 7 to amplify instrument sound and reduce the dependence of instrument manufacturing industry on rare woods at the same time. The reduction on the dependence on are woods to manufacture instruments, plays a significant role in protecting green forest and promoting worldwide environmental protection, especially for protecting the rare woods commonly used to make instruments.

The device 100 picks up the sound of instrument directly and applies the transducer 7 to achieve resonance enhancement of instrument body, so as to make the sound made by instrument stronger. In addition to commonly used volume and tone control functions, the digital reverberation module and the effect module are especially added. The addition of these modules have good practicability, enables broad market sales prospect and creates good economic benefit.

The present invention would be used on an instrument 125 of any type such as but not limited to a pickup, guitar, ukulele, violin, guqin, guzheng and mandolin. Namely, the stringed instrument pickup and feedback system 150 of the present invention can be applied on a pickup, the pickup makes use of the sound pickup device for the synchronous vibration adding of instrument by means of the transducer 7. Likewise, the present invention can be applied on any stringed instrument, the stringed instrument makes use of the sound pickup device for the resonance enhancement of the instrument body 9 by means of the transducer 7.

Considering the above, the present invention not only amplifies instrument sound but also reduces the dependence of the instrument manufacturing industry on rare woods. A decreased dependence on use of rare woods to manufacture stringed instruments plays a significant role in protecting green forest and promoting worldwide environmental protection, especially for protecting the rare woods commonly used to make instruments. Furthermore, by clinging or disposing of the transducer to the surface of the instrument, the present invention is able to lower material and manufacturing costs to make instruments, resulting in broad market sales prospect and good economic benefit.

While specific embodiments of the invention have been described and illustrated, such embodiments should be considered illustrative of the invention only and not as limiting the invention as construed in accordance with the accompanying claims. One of ordinary skill in the art could alter the above embodiments or provide insubstantial changes that may be made without departing from the scope of the invention. Those skilled in the art can make use of the above technical contents disclosed to make some equivalent changes, such as modification, decoration and evolution without departure from the technical solution of the invention, and they are regarded as equivalent embodiments of the invention; besides, all equivalent changes, such as modification, decoration and evolution made on the above embodiment according to the substantial technology of the invention are within the scope of the technical solution of the invention.

1. A stringed instrument pickup and feedback system comprising:
at least one sound pickup member;
an output transducer; and
a control processor connected to the at least one sound pickup member and the output transducer,
wherein the control processor is configured to receive signals from the at least one sound pickup member corresponding to detected sound from a stringed instrument and process said received signals into output control signals,
wherein the control processor is configured to send said output control signals to the output transducer to resonate the output transducer through a predetermined range of frequencies.

2. The system according to claim 1, wherein the transducer is disposed on a surface of the stringed instrument and connected with a power supply.

3. The system according to claim 1, wherein the at least one instrument pickup comprises a microphone pickup, a magnetic pickup, a piezo saddle pickup, a pressure pickup and a coil induced pickup.

4. The system according to claim 3, wherein the magnetic pickup is installed within a sound hole of the stringed instrument directly below the strings.

5. The system according to claim 3, wherein the piezo saddle pickup is installed within the saddle of the stringed instrument.

6. The system according to claim 3, wherein the pressure pickup is installed within the body of the stringed instrument

7. The system according to claim 3, wherein the pressure pickup is installed on the external surface of the soundboard.

8. The system according to claim 1, wherein the system further includes a sound processing circuit.

9. The system according to claim 8, wherein the sound processing circuit comprises a volume control unit, a tone processing unit, a power amplifier circuit, a voltage stabilizing circuit, a reverberation module and an effect module

10. The system according to claim 8, wherein the sound processing circuit is electrically connected to a power supply.

11. The system of claim 8, wherein the reverberation module is at least one adjustable and optional reverberation control modules.

12. The system of claim 8, wherein the effect module is at least one adjustable and optional sound effect control modules.

13. The system according to claim 1, further comprising a power supply.

14. The system according to claim 13, wherein the power supply is connected with and supplies power to the sound processing circuit and the output transducer.

15. The system according to claim 1, wherein the stringed instrument can be a pickup, guitar, ukulele, violin, Guqin, Guzheng and Mandolin.

16. The system according to claim 1, wherein the transducer is disposed on an inside back surface of the stringed instrument.

17. The system according to claim 8, wherein the control processor and said sound processing circuit processes an original signal.
